(19) United States
(12) Patent Application Publication
(10) Pub. No.: US 2024/0269657 A1
(43) Pub. Date: Aug. 15, 2024

(54) COMPOSITE ZEOLITE SCR CATALYST, PREPARATION METHOD THEREFOR AND USE THEREOF

(71) Applicant: RESEARCH CENTER FOR ECO-ENVIRONMENTAL SCIENCES, CHINESE ACADEMY OF SCIENCES, Beijing (CN)

(72) Inventors: Hong HE, Beijing (CN); Yulong SHAN, Beijing (CN); Junlin CHEN, Beijing (CN); Xiaoyan SHI, Beijing (CN); Yunbo YU, Beijing (CN)

(21) Appl. No.: 18/562,062

(22) PCT Filed: Aug. 15, 2022
(86) PCT No.: PCT/CN2022/112422

§ 371 Date: Nov. 17, 2023

(30) Foreign Application Priority Data
May 10, 2022 (CN) 202210507457.6

(51) Int. Cl. B01J 29/80; B01D 53/94; B01J 37/04; B01J 37/08

(52) U.S. Cl. CPC B01J 29/80; B01D 53/9427; B01J 37/04; B01J 37/08; B01D 2255/50; B01D 2257/404; B01D 2258/012; B01J 2229/18

(57) ABSTRACT

Disclosed are a composite zeolite SCR catalyst, a preparation method therefor and use thereof. The composite zeolite SCR catalyst comprises a Cu-based zeolite and a first hydrogen-type zeolite; the composite zeolite SCR catalyst has a NOₓ removal efficiency of more than or equal to 80% at more than or equal to 300° C.; the composite zeolite SCR catalyst is subjected to hydrothermal treatment at 750-950° C. for 10-16 h, and the hydrothermally treated composite zeolite SCR catalyst has a NOₓ removal efficiency of more than or equal to 60% at more than or equal to 300° C. The composite zeolite SCR catalyst of the present application is used in the technology of selective catalytic reduction on nitrogen oxides with ammonia, and the composite zeolite SCR catalyst has simple composition, low preparation cost, great catalytic performance and good hydrothermal stability.

### TECHNICAL FIELD

Embodiments of the present application relate to the technical field of industrial gas exhaust treatment and environmentally friendly catalytic materials, such as a composite zeolite SCR catalyst, and especially, a composite zeolite SCR catalyst, a preparation method therefor and use thereof.

### BACKGROUND

Road freight and waterway freight, for which diesel engines are the main source of motive power, account for 73.0% and 15.9% of China's total freight transportation, respectively, and cannot be completely replaced for a considerable period of time in the future. In order to reduce CO₂ emissions, diesel engines need to be further improved in thermal efficiency and fuel economy, which, nevertheless, is often accompanied by further increased thermal NOₓ emissions of the original diesel engine. Hence, there is a need to further improve the NOₓ removal efficiency of the aftertreatment system to eliminate the large amount of NOₓ that is produced for the fuel efficiency enhancement, realizing the simultaneous reduction of carbon and pollutants in diesel engines. The main technical means to purify NOₓ emissions from diesel vehicles and diesel engines is to convert nitrogen oxides to N₂ by selective catalytic reduction with ammonia (NH₃) as a reductant (NH₃-SCR), the central to which is the utilization of high-performance NH₃-SCR catalysts. Currently, Cu-CHA zeolite molecular sieves are the common commercial catalysts, and in order to ensure their stability, high-silica zeolite catalysts are usually employed; however, the high-silica zeolite catalysts have limited NH₃-SCR catalytic activity at low temperature. Meanwhile, although some aluminum-rich zeolite molecular sieve catalysts have excellent NH₃-SCR catalytic activity, their poor stability limits their application.

CN110546108A discloses a crystalline copper-containing small-pore aluminosilicate zeolite, which has a maximum pore size of eight tetrahedral atoms, contains 2% to 7% by weight of copper calculated in terms of CuO based on a total weight of the corresponding zeolite, contains 0.1% to 0.4% by weight of alkali metal cations calculated in terms of pure metal based on a total weight of the zeolite, and has an BET surface area of 320 m²/g to 750 m²/g. Moreover, this application discloses a method for preparing the zeolite, and the method comprises preparing an aqueous reaction mixture, wherein the aqueous reaction mixture comprises a zeolite with octahedral framework, copper-tetraethylenepentamine (Cu-TEPA), and at least one M(OH)ₓ compound, wherein x is selected from lithium, sodium, potassium, rubidium and cesium; and heating the reaction mixture to form the copper-containing small-pore zeolite. However, the crystalline copper-containing small-pore aluminosilicate zeolite has low SCR catalytic activity at low temperatures, which cannot satisfy the requirements of energy conservation and emission reduction.

CN104066508A discloses a catalyst preferably for use in selective catalytic reduction (SCR); the catalyst comprises one or more zeolites with BEA structure, one or more zeolites with CHA structure, and optionally one or more zeolites with MFI structure, wherein at least a portion of the one or more zeolites with BEA structure contains iron (Fe), wherein at least a portion of the one or more zeolites with CHA structure contains copper (Cu), and wherein at least a portion of the optionally one or more zeolites with MFI structure contains iron (Fe). Additionally, this application relates to a gas exhaust treatment system comprising the catalyst and a method for treating a NOₓ-containing gas stream by using the catalyst. However, the catalyst has a complex composition and high preparation cost.

CN111068763A discloses a catalyst for preparing methyl acetate by the dimethyl ether carbonylation and a preparation method therefor and a method for synthesizing methyl acetate, which mainly solves the technical problems that the catalysts in the art have high selectivity in the by-products low-carbon hydrocarbons (C1-C4 alkanes, C1-C4 olefins) and low yields of the main product methyl acetate. By using the catalyst for preparing methyl acetate by the dimethyl ether carbonylation, the technical solution, which comprises a carrier and an active component, wherein the carrier comprises a hydrogen-type zeolite molecular sieve; and the active component comprises, in terms of a volume of the catalyst, (1) greater than 0 g/L and less than or equal to 20 g/L of Cu or Cu oxides, in terms of Cu; and (2) greater than 0 g/L and less than or equal to 20 g/L of lanthanide oxides, in terms of lanthanides, achieves a good result, and can be used in the industrial production for dimethyl ether carbonylation to methyl acetate. However, the catalyst for preparing methyl acetate by the dimethyl ether carbonylation and the preparation method therefor require lanthanide oxides, which results in a high preparation cost of the catalyst for the dimethyl ether carbonylation to methyl acetate.

So far the SCR catalysts disclosed all have certain defects and suffer from low low-temperature NH₃-SCR catalytic activity, poor thermal stability, complex composition and high preparation cost. Therefore, it is important to develop and design a novel composite zeolite SCR catalyst, a preparation method therefor and use thereof.

### SUMMARY

The following is a summary of the subject matter described in detail herein. The summary is not intended to limit the protection scope of the claims.

An embodiment of the present application provides a composite zeolite SCR catalyst, a preparation method therefor and use thereof, wherein the composite zeolite SCR catalyst of the present application is used in the technology of selective catalytic reduction on nitrogen oxides with ammonia, and the composite zeolite SCR catalyst has simple composition, low preparation cost, great catalytic performance and good hydrothermal stability.

In a first aspect, an embodiment of the present application provides a composite zeolite SCR catalyst, and the composite zeolite SCR catalyst comprises a Cu-based zeolite and a first hydrogen-type zeolite;
the composite zeolite SCR catalyst has a NOₓ removal efficiency of more than or equal to 80% at more than or equal to 300° C.;
the composite zeolite SCR catalyst is subjected to hydrothermal treatment at 750-950° C. for 10-16 h, and the hydrothermally treated composite zeolite SCR catalyst has a NOₓ removal efficiency of more than or equal to 60% at more than or equal to 300° C.

The NOₓ in the present application refers to nitrogen oxides, and the nitrogen oxides comprise any one or a combination of at least two of nitrous oxide (N₂O), nitric oxide (NO), nitrogen dioxide (NO₂), dinitrogen trioxide (N₂O₃), dinitrogen tetroxide (N₂O₄) and dinitrogen pentoxide (N₂O₅); a typical but non-limiting combination comprises a combination of N₂O and NO, a combination of NO and NO₂, a combination of NO₂ and N₂O₃, a combination of N₂O₃ and N₂O₄, a combination of N₂O₄ and N₂O₅, a combination of N₂O, NO and NO₂, or a combination of NO₂, N₂O₃, N₂O₄ and N₂O₅.

The catalytic activity of the first hydrogen-type zeolite of the present application is low, and the catalytic activity of the Cu-based zeolite is high; the composite zeolite SCR catalyst comprises the Cu-based zeolite and the first hydrogen-type zeolite, and the composite zeolite SCR catalyst has a similar catalytic performance as the same mass of Cu-based zeolite; meanwhile, the composite zeolite SCR catalyst has a superior hydrothermal stability than the same mass of Cu-based zeolite.

The composite zeolite SCR catalyst of the present application is used in the technology of selective catalytic reduction on nitrogen oxides with ammonia, and the composite zeolite SCR catalyst has simple composition, low preparation cost, great catalytic performance and good hydrothermal stability.

The composite catalyst of Cu-based zeolite and hydrogen-type zeolite of the present application has excellent hydrothermal stability because there are a large number of vacant aluminum sites in the hydrogen-type zeolite, and Cu²⁺ in the Cu-based zeolite migrates into the hydrogen-type zeolite after the composite process, which is conducive to maintaining the stability of the molecular sieve framework; however, for the common SCR catalysts, large particles of CuOₓ are produced due to the agglomeration of copper species, leading to the inferior hydrothermal stability. Therefore, the hydrothermal stability of the composite catalyst of Cu-based zeolite and hydrogen-type zeolite in the present application is superior to that of the common SCR catalyst.

Preferably, the Cu-based zeolite and the first hydrogen-type zeolite have a mass ratio of (3-30):3, such as 3:3, 5:3, 7:3, 9:3, 10:3, 12:3, 14:3, 16:3, 18:3, 20:3, 22:3, 24:3, 26:3, 28:3 or 30:3; however, the mass ratio is not limited to the listed values, and other unlisted values within the numerical range are also applicable; preferably, the mass ratio is (6-15):3; when the mass ratio of the Cu-based zeolite to the first hydrogen-type zeolite is low, the NOₓ conversion efficiency will be reduced due to the presence of a large amount of hydrogen-type zeolite, and the low content of active sites in the catalyst cannot give good catalytic effect; when the mass ratio of the Cu-based zeolite to the first hydrogen-type zeolite is high, the NOₓ conversion efficiency will be high and the hydrothermal stability will be reduced, because the composite catalyst system approximates to a pure Cu-based zeolite catalyst in the case of existing a large amount of Cu-based zeolite catalyst, and after the hydrothermal aging, the framework is prone to dealumination and copper is easy to be agglomerated resulting in activity reduction, and therefore, the hydrothermal stability will be reduced.

In a second aspect, an embodiment of the present application provides a preparation method for the composite zeolite SCR catalyst according to the first aspect, and the preparation method comprises:
mixing the Cu-based zeolite with the first hydrogen-type zeolite to obtain the composite zeolite SCR catalyst.

The preparation method of the composite zeolite SCR catalyst of the present application has simple process and low preparation cost.

Preferably, the Cu-based zeolite has a structural type comprising any one or a combination of at least two of CHA, AEI, KFI, LTA, AFX, ERI, GIS, LEV, RTH, RHO or SFW; a typical but non-limiting combination comprises a combination of AEI and KFI, a combination of KFI and LTA, a combination of AFX and ERI, a combination of GIS and LEV, a combination of RTH and RHO, a combination of RTH, RHO and SFW, or a combination of AEI, KFI, LTA and AFX.

Preferably, the Cu-based zeolite contains Cu in a mass fraction of not less than 2.4 wt % based on a mass of the Cu-based zeolite, such as 2.4 wt %, 2.5 wt %, 2.6 wt %, 2.8 wt %, 3 wt %, 3.2 wt %, 3.5 wt %, 4 wt %, 5 wt %, 6 wt %, 8 wt %, 10 wt % or 15 wt %; however, the mass fraction is not limited to the listed values, and other unlisted values within the numerical range are also applicable.

Preferably, silicon dioxide and aluminum oxide in the Cu-based zeolite have a molar ratio of (5-20):1, such as 5:1, 6:1, 7:1, 8:1, 9:1, 10:1, 11:1, 12:1, 13:1, 14:1, 15:1, 16:1, 17:1, 18:1, 19:1 or 20:1; however, the molar ratio is not limited to the listed values, and other unlisted values within the numerical range are also applicable.

The molar ratio of silicon dioxide to aluminum oxide in the Cu-based zeolite of the present application is low, and the composite zeolite SCR catalyst prepared from the Cu-based zeolite has high SCR catalytic activity and hydrothermal stability.

Preferably, the first hydrogen-type zeolite has a structural type comprising any one or a combination of at least two of CHA, AEI, KFI, LTA, AFX, ERI, GIS, LEV, RTH, RHO or SFW; a typical but non-limiting combination comprises a combination of CHA and KFI, a combination of LTA and AFX, a combination of AFX and ERI, a combination of ERI and GIS, a combination of LEV and RTH, and a combination of RHO and SFW, a combination of CHA, KFI and LTA, or a combination of KFI, LTA, AFX and ERI.

Preferably, a molar ratio of silicon dioxide to aluminum oxide in the first hydrogen-type zeolite is not less than the molar ratio of silicon dioxide to aluminum oxide in the Cu-based zeolite; when the molar ratio of silicon dioxide to aluminum oxide in the first hydrogen-type zeolite is higher than the molar ratio of silicon dioxide to aluminum oxide in the Cu-based zeolite, the NOₓ conversion efficiency will be reduced and the hydrothermal stability will be increased, because the hydrogen-type zeolite has more paired aluminum sites due to the low silicon-aluminum ratio, and the paired aluminum sites are more easily to form Cu²⁺-2Al with Cu²⁺ maintaining the stability of the framework, and therefore the hydrothermal stability will be improved.

Preferably, the mixing comprises any one or a combination of at least two of liquid-liquid mixing, solid-liquid mixing or solid-solid mixing; a typical but non-limiting combination comprises a combination of liquid-liquid mixing and solid-liquid mixing, solid-liquid mixing and solid-solid mixing, or a combination of liquid-liquid mixing, solid-liquid mixing and solid-solid mixing.

Preferably, the solid-solid mixing comprises grinding.

Preferably, a preparation method for the Cu-based zeolite comprises the following steps:
(1) mixing a second hydrogen-type zeolite with an ammonium chloride solution, and performing drying to obtain an intermediate; and
(2) mixing the intermediate with a copper salt solution, and performing drying and then calcining to obtain the Cu-based zeolite.

The structural type of the second hydrogen-type zeolite of the present application is the same as the structural type of the Cu-based zeolite, the molar ratio of silicon dioxide to aluminum oxide in the second hydrogen-type zeolite is the same as that of the Cu-based zeolite, and there is no relationship between the second hydrogen-type zeolite and the first hydrogen-type zeolite.

Preferably, the mixing in step (1) has a temperature of 60-90° C., such as 60° C., 65° C., 70° C., 75° C., 80° C., 85° C. or 90° C.; however, the temperature is not limited to the listed values, and other unlisted values within the numerical range are also applicable.

Preferably, a method of the mixing in step (1) comprises stirring at a speed of 300-700 rpm, such as 300 rpm, 320 rpm, 350 rpm, 370 rpm, 400 rpm, 420 rpm, 450 rpm, 470 rpm, 500 rpm, 520 rpm, 550 rpm, 570 rpm, 600 rpm, 620 rpm, 650 rpm, 680 rpm or 700 rpm; however, the speed is not limited to the listed values, and other unlisted values within the numerical range are also applicable.

Preferably, the second hydrogen-type zeolite and the ammonium chloride solution in step (1) have a solid-liquid ratio of 1:(80-120, such as 1:80, 1:85, 1:90, 1:95, 1:100, 1:105, 1:110, 1:115 or 1:120; however, the solid-liquid ratio is not limited to the listed values, and other unlisted values within the numerical range are also applicable, and the solid-liquid ratio has a unit of g/mL.

Preferably, the ammonium chloride solution in step (1) has a concentration of 0.1-0.2 mol/L, such as 0.1 mol/L, 0.11 mol/L, 0.12 mol/L, 0.13 mol/L, 0.14 mol/L, 0.15 mol/L, 0.16 mol/L, 0.17 mol/L, 0.18 mol/L, 0.19 mol/L or 0.2 mol/L; however, the concentration is not limited to the listed values, and other unlisted values within the numerical range are also applicable.

Preferably, the drying in step (1) has a temperature of 80-120° C., such as 80° C., 85° C., 90° C., 95° C., 100° C., 105° C., 110° C., 115° C. or 120° C.; however, the temperature is not limited to the listed values, and other unlisted values within the numerical range are also applicable.

Preferably, the mixing in step (2) has a temperature of 40-60° C., such as 40° C., 42° C., 45° C., 48° C., 50° C., 52° C., 55° C., 58° C. or 60° C.; however, the temperature is not limited to the listed values, and other unlisted values within the numerical range are also applicable.

Preferably, a method of the mixing in step (2) comprises stirring at a speed of 300-700 rpm, such as 300 rpm, 320 rpm, 350 rpm, 370 rpm, 400 rpm, 420 rpm, 450 rpm, 470 rpm, 500 rpm, 520 rpm, 550 rpm, 570 rpm, 600 rpm, 620 rpm, 650 rpm, 680 rpm or 700 rpm; however, the speed is not limited to the listed values, and other unlisted values within the numerical range are also applicable.

Preferably, the intermediate and the copper salt solution in step (2) have a solid-liquid ratio of 1:(80-120), such as 1:80, 1:85, 1:90, 1:95, 1:100, 1:105, 1:110, 1:115 or 1:120; however, the solid-liquid ratio is not limited to the listed values, and other unlisted values within the numerical range are also applicable, and the solid-liquid ratio has a unit of g/mL.

Preferably, a copper salt in the copper salt solution in step (2) comprises any one or a combination of at least two of copper acetate, copper nitrate or copper sulfate; a typical but non-limiting combination comprises a combination of copper acetate and copper nitrate, a combination of copper nitrate and copper sulfate, or a combination of copper acetate, copper nitrate and copper sulfate.

Preferably, the copper salt solution in step (2) has a concentration of 0.1-0.5 mol/L, such as 0.1 mol/L, 0.15 mol/L, 0.2 mol/L, 0.25 mol/L, 0.3 mol/L, 0.35 mol/L, 0.4 mol/L, 0.45 mol/L or 0.5 mol/L; however, the concentration is not limited to the listed values, and other unlisted values within the numerical range are also applicable.

Preferably, the drying in step (2) has a temperature of 80-120° C., such as 80° C., 85° C., 90° C., 95° C., 100° C., 105° C., 110° C., 115° C. or 120° C.; however, the temperature is not limited to the listed values, and other unlisted values within the numerical range are also applicable.

Preferably, the calcining in step (2) has a temperature of 400-600° C. and a time of 5-8 h.

The temperature of the calcining is limited to 400-600° C. in the present application, such as 400° C., 420° C., 450° C., 480° C., 500° C., 520° C., 550° C., 580° C. or 600° C.; however, the temperature is not limited to the listed values, and other unlisted values within the numerical range are also applicable.

The time of the calcining is limited to 5-8 h in the present application, such as 5 h, 5.2 h, 5.5 h, 5.8 h, 6 h, 6.2 h, 6.5 h, 6.8 h, 7 h, 7.2 h, 7.5 h, 7.8 h or 8 h; however, the time is not limited to the listed values, and other unlisted values within the numerical range are also applicable.

In a third aspect, an embodiment of the present application provides use of the composite zeolite SCR catalyst according to the first aspect, wherein the composite zeolite SCR catalyst is used for selective catalytic reduction on nitrogen oxides from diesel vehicle exhaust.

Preferably, the composite zeolite SCR catalyst is mixed with an additive to obtain a slurry, and the slurry is coated on a honeycomb ceramic, and dried and roasted in sequence to be used for selective catalytic reduction on nitrogen oxides from diesel vehicle exhaust.

Compared with the related art, the embodiments of the present application have the following beneficial effects:
(1) the composite zeolite SCR catalyst provided by the embodiment of the present application has a similar catalytic performance as the same mass of Cu-based zeolite; meanwhile, the composite zeolite SCR catalyst has a superior hydrothermal stability than the same mass of Cu-based zeolite;
(2) the composite zeolite SCR catalyst provided by the embodiment of the present application has a NOₓ removal efficiency of more than or equal to 80% at more than or equal to 300° C.; after the hydrothermal treatment at 750-950° C. for 10-16 h, the hydrothermally treated composite zeolite SCR catalyst has a NOₓ removal efficiency of more than or equal to 60% at more than or equal to 300° C.; and
(3) the composite zeolite SCR catalyst in the embodiment of the present application is used in the technology of selective catalytic reduction on nitrogen oxides with ammonia, and the composite zeolite SCR catalyst has simple composition, low preparation cost, great catalytic performance and good hydrothermal stability.

Other aspects can become apparent upon reading and understanding the drawings and the detailed description.

### BRIEF DESCRIPTION OF DRAWINGS

Drawings are used to provide further understanding of the technical solutions herein, constitute part of the specification, and explain the technical solutions herein in conjunction with embodiments of the present application, but do not constitute a limitation on the technical solutions herein.

FIG. 1 shows NOₓ conversion efficiency curves of a composite zeolite SCR catalyst and a hydrothermally treated composite zeolite SCR catalyst in Example 1 at different temperatures.

FIG. 2 shows NOₓ conversion efficiency curves of a composite zeolite SCR catalyst and a hydrothermally treated composite zeolite SCR catalyst in Example 2 at different temperatures.

FIG. 3 shows NOₓ conversion efficiency curves of Cu-KFI and hydrothermally treated Cu-KFI in Comparative Example 1 at different temperatures.

FIG. 4 shows NOₓ conversion efficiency curves of H-CHA-1 and hydrothermally treated H-CHA-1 in Comparative Example 2 at different temperatures.

### DETAILED DESCRIPTION

The technical solutions of the present application are further described below in terms of specific embodiments. It should be clear to those skilled in the art that the examples are merely used for a better understanding of the present application and should not be regarded as a particular limitation on the present application.

### Example 1

This example provides a composite zeolite SCR catalyst, and the composite zeolite SCR catalyst comprises a Cu-based zeolite with a KFI structure (Cu-KFI) and a hydrogen-type zeolite with an AEI structure (H-AEI) in a mass ratio of 12:3.

A preparation method for the composite zeolite SCR catalyst comprises:

Cu-KFI was mixed with H-AEI by grinding to obtain the composite zeolite SCR catalyst;
based a mass of Cu-KFI, Cu in the Cu-KFI had a mass fraction of 3.0%, and silicon dioxide and aluminum oxide had a molar ratio of 10:1; silicon dioxide and aluminum oxide in the H-AEI had a molar ratio of 23:1.

A preparation method for the Cu-KFI comprises the following steps:
(1) a hydrogen-type zeolite with a KFI structure (H-KFI) was mixed with an ammonium chloride solution at a concentration of 0.2 mol/L by stirring at 80° C. with a speed of 500 rpm, wherein the H-KFI and the ammonium chloride solution had a solid-liquid ratio of 1:100 in g/mL, and the mixture was dried at 100° C. to obtain an intermediate; and
(2) the intermediate was mixed with a copper nitrate solution at a concentration of 0.4 mol/L by stirring at 40° C. with a speed of 500 rpm, wherein the intermediate and the copper nitrate solution had a solid-liquid ratio of 1:100 in g/mL, and the mixture was dried at 90° C. and then calcined at 600° C. for 6 h to obtain the Cu-KFI.

### Example 2

This example provides a composite zeolite SCR catalyst, and the composite zeolite SCR catalyst comprises a Cu-based zeolite with a CHA structure (Cu-CHA) and a first hydrogen-type zeolite with a CHA structure (H-CHA-1) in a mass ratio of 15:3.

A preparation method for the composite zeolite SCR catalyst comprises:

Cu-CHA was mixed with H-CHA-1 by grinding to obtain the composite zeolite SCR catalyst;
based a mass of Cu-CHA, Cu in the Cu-CHA had a mass fraction of 4.2%, and silicon dioxide and aluminum oxide had a molar ratio of 9:1; silicon dioxide and aluminum oxide in the H-CHA-1 had a molar ratio of 23:1.

A preparation method for the Cu-CHA comprises the following steps:
(1) a second hydrogen-type zeolite with a CHA structure (H-CHA-2) was mixed with an ammonium chloride solution at a concentration of 0.18 mol/L by stirring at 85° C. with a speed of 500 rpm, wherein the H-CHA-2 and the ammonium chloride solution had a solid-liquid ratio of 1:80 in g/mL, and the mixture was dried at 110° C. to obtain an intermediate; and
(2) the intermediate was mixed with a copper sulfate solution at a concentration of 0.3 mol/L by stirring at 45° C. with a speed of 600 rpm, wherein the intermediate and the copper sulfate solution had a solid-liquid ratio of 1:110 in g/mL, and the mixture was dried at 110° C. and then calcined at 450° C. for 7 h to obtain the Cu-CHA.

### Example 3

This example provides a composite zeolite SCR catalyst, and the composite zeolite SCR catalyst comprises a Cu-based zeolite with a CHA structure (Cu-CHA) and a hydrogen-type zeolite with a KFI structure (H-KFI) in a mass ratio of 6:3.

A preparation method for the composite zeolite SCR catalyst comprises: Cu-CHA was mixed with H-KFI by grinding to obtain the composite zeolite SCR catalyst; based a mass of Cu-CHA, Cu in the Cu-CHA had a mass fraction of 3.4%, and silicon dioxide and aluminum oxide had a molar ratio of 5:1; silicon dioxide and aluminum oxide in the H-KFI had a molar ratio of 10:1.

A preparation method for the Cu-CHA comprises the following steps:
(1) a hydrogen-type zeolite with a CHA structure (H-CHA) was mixed with an ammonium chloride solution at a concentration of 0.15 mol/L by stirring at 70° C. with a speed of 700 rpm, wherein the H-CHA and the ammonium chloride solution had a solid-liquid ratio of 1:120 in g/mL, and the mixture was dried at 80° C. to obtain an intermediate; and
(2) the intermediate was mixed with a copper acetate solution at a concentration of 0.5 mol/L by stirring at 50° C. with a speed of 400 rpm, wherein the intermediate and the copper acetate solution had a solid-liquid ratio of 1:80 in g/mL, and the mixture was dried at 80° C. and then calcined at 550° C. for 5 h to obtain the Cu-CHA.

### Example 4

This example provides a composite zeolite SCR catalyst, and the composite zeolite SCR catalyst comprises a Cu-based zeolite with a KFI structure (Cu-KFI) and a hydrogen-type zeolite with a CHA structure (H-CHA) in a mass ratio of 3:3.

A preparation method for the composite zeolite SCR catalyst comprises:
Cu-KFI was mixed with H-CHA by grinding to obtain the composite zeolite SCR catalyst;
based a mass of Cu-KFI, Cu in the Cu-KFI had a mass fraction of 3.1%, and silicon dioxide and aluminum oxide had a molar ratio of 8:1; silicon dioxide and aluminum oxide in the H-CHA had a molar ratio of 21:1.

A preparation method for the Cu-KFI comprises the following steps:
(1) a hydrogen-type zeolite with a KFI structure (H-KFI) was mixed with an ammonium chloride solution at a concentration of 0.2 mol/L by stirring at 60° C. with a speed of 400 rpm, wherein the H-KFI and the ammonium chloride solution had a solid-liquid ratio of 1:90 in g/mL, and the mixture was dried at 90° C. to obtain an intermediate; and
(2) the intermediate was mixed with a copper nitrate solution at a concentration of 0.2 mol/L by stirring at 60° C. with a speed of 300 rpm, wherein the intermediate and the copper nitrate solution had a solid-liquid ratio of 1:120 in g/mL, and the mixture was dried at 100° C. and then calcined at 600° C. for 6 h to obtain the Cu-KFI.

### Example 5

This example provides a composite zeolite SCR catalyst, which is same as Example 1 except that the Cu-KFI and H-AEI had a mass ratio of 1:3.

### Example 6

This example provides a composite zeolite SCR catalyst, which is same as Example 1 except that the Cu-KFI and H-AEI had a mass ratio of 35:3.

### Example 7

This example provides a composite zeolite SCR catalyst, which is same as Example 1 except that silicon dioxide and aluminum oxide in the H-CHA-1 had a molar ratio of 8:1.

### Comparative Example 1

This comparative example provides a Cu-KFI, and the Cu-KFI was prepared by the preparation method for Cu-KFI in Example 1.

### Comparative Example 2

This comparative example provides an H-CHA-1, and the H-CHA is same as the H-CHA-1 in Example 2.

The composite zeolite SCR catalysts in Examples 1-7, the Cu-KFI in Comparative Example 1 and the H-CHA-1 in Comparative Example 2 were subjected to hydrothermal treatment by equal mass, and the hydrothermal treatment includes: appropriate amounts of the composite zeolite SCR catalysts, Cu-KFI and H-CHA-1 were separately added into quartz tubes and placed into a temperature-controllable resistance furnace, air containing 10% water was introduced as a carrier gas at a flow rate of 500 mL/min, and the zeolites were treated at 800° C. for 10 h to obtain the hydrothermally treated composite zeolite SCR catalysts, hydrothermally treated Cu-KFI and hydrothermally treated H-CHA-1.

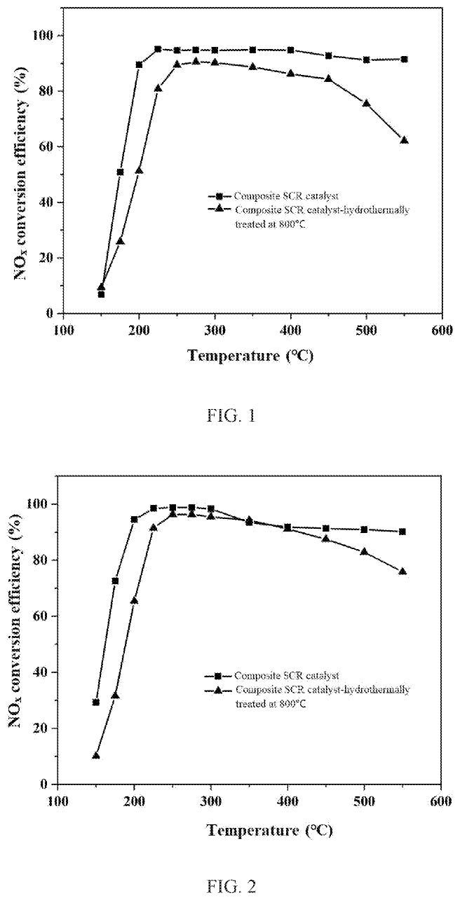

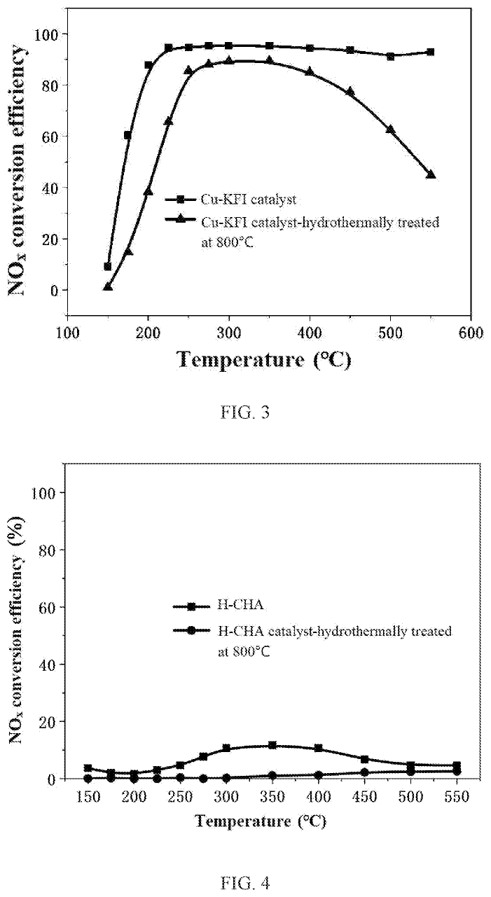

The composite zeolite SCR catalysts in Examples 1-7, the Cu-KFI in Comparative Example 1, the H-CHA-1 in Comparative Example 2, the hydrothermally treated composite zeolite SCR catalysts, the hydrothermally treated Cu-KFI and the hydrothermally treated H-CHA-1 were used in the NH₃-SCR catalytic reaction by equal mass:
test gas was introduced for the test, the composition of the exhaust gas was detected by a Fourier transform infrared spectrometer, and the NOₓ conversion efficiency was calculated; the test space velocity was 100000 h⁻¹, the composition of the test gas was 500 ppm NO, 500 ppm NH₃, and 5% O₂, and the equilibrium gas was N₂; the curve and data on the changes of NOₓ conversion efficiency with the reaction temperature were measured;
the NOₓ conversion efficiencies of the composite zeolite SCR catalysts, Cu-KFI and H-CHA-1 on the NH₃-SCR catalytic reaction at different reaction temperatures are shown in Table 1;
the NOₓ conversion efficiencies of the hydrothermally treated composite zeolite SCR catalysts, the hydrothermally treated Cu-KFI and the hydrothermally treated H-CHA-1 on the NH₃-SCR catalytic reaction at different reaction temperatures are shown in Table 2;
the NOₓ conversion efficiency curves of the composite zeolite SCR catalyst and the hydrothermally treated composite zeolite SCR catalyst in Example 1 at different temperatures are shown in FIG. 1;
the NOₓ conversion efficiency curves of the composite zeolite SCR catalyst and the hydrothermally treated composite zeolite SCR catalyst in Example 2 at different temperatures are shown in FIG. 2;
the NOₓ conversion efficiency curves of the Cu-KFI and the hydrothermally treated Cu-KFI in Comparative Example 1 at different temperatures are shown in FIG. 3;
the NOₓ conversion efficiency curves of the H-CHA-1 and the hydrothermally treated H-CHA-1 in Comparative Example 2 at different temperatures are shown in FIG. 4.

TABLE 1

| | NOₓ conversion efficiency (%) | |
|---|---|---|
| | 300° C. | 500° C. |
| Example 1 | 94.7 | 91.2 |
| Example 2 | 98.3 | 90.9 |
| Example 3 | 98.4 | 91.5 |
| Example 4 | 93.3 | 90.9 |
| Example 5 | 75.2 | 82.1 |
| Example 6 | 95.4 | 92.4 |
| Example 7 | 98.9 | 93.6 |
| Comparative | 95.4 | 91.1 |
| Example 1 | | |
| Comparative | 4.0 | 5.3 |
| Example 2 | | |

TABLE 2

| | NOₓ conversion efficiency (%) | |
|---|---|---|
| | 300° C. | 500° C. |
| Example 1 | 90.3 | 75.5 |
| Example 2 | 95.4 | 82.9 |
| Example 3 | 93.5 | 80.5 |
| Example 4 | 88.6 | 70.4 |
| Example 5 | 74.9 | 79.2 |
| Example 6 | 75.2 | 67.8 |
| Example 7 | 5.9 | 1.0 |
| Comparative | 89.5 | 62.6 |
| Example 1 | | |
| Comparative | 1.3 | 7.5 |
| Example 2 | | |

As can be found from Table 1, Table 2 and FIGS. 1-4:
(1) The composite zeolite SCR catalysts obtained in Examples 1-4 have high NOₓ conversion efficiencies on the NH₃-SCR catalytic reaction, even after the hydrothermal treatment at 800° C.; the composite zeolite SCR catalyst of the present application is used in the technology of selective catalytic reduction on nitrogen oxides with ammonia, and the composite zeolite SCR catalyst has simple composition, low preparation cost, great catalytic performance and good hydrothermal stability.
(2) As can be seen from the comparison of Example 1 with Examples 5-6, the mass ratio of the Cu-based zeolite to the first hydrogen-type zeolite in the composite zeolite SCR catalyst of the present application can affect the NOₓ conversion efficiency on the NH₃-SCR catalytic reaction; when the mass ratio of the Cu-based zeolite to the first hydrogen-type zeolite is low, the NOₓ conversion efficiency will be reduced due to the presence of a large amount of hydrogen-type zeolite, and the low content of active sites in the catalyst cannot give good catalytic effect; when the mass ratio of the Cu-based zeolite to the first hydrogen-type zeolite is high, the NOₓ conversion efficiency will be high and the hydrothermal stability will be reduced, because the composite catalyst system approximates to a pure Cu-based zeolite catalyst in the case of existing a large amount of Cu-based zeolite catalyst, and after the hydrothermal aging, the framework is prone to dealumination and copper is easy to be agglomerated resulting in activity reduction, and therefore, the hydrothermal stability will be reduced.
(3) As can be seen from the comparison of Example 2 with Example 7, the molar ratio of silicon dioxide to aluminum oxide in the first hydrogen-type zeolite of the present application can affect the NOₓ conversion efficiency on the NH₃-SCR catalytic reaction; when the molar ratio of silicon dioxide to aluminum oxide in the first hydrogen-type zeolite is higher than the molar ratio of silicon dioxide to aluminum oxide in the Cu-based zeolite, the NOₓ conversion efficiency will be reduced and the hydrothermal stability will be increased, because the hydrogen-type zeolite has more paired aluminum sites due to the low silicon-aluminum ratio, and the paired aluminum sites are more easily to form Cu²⁺-2Al with Cu²⁺ maintaining the stability of the framework, and therefore the hydrothermal stability will be improved.
(4) As can be seen from the comparison of Example 1 with Comparative Example 1 and Example 2 with Comparative Example 2, the catalytic activity of the first hydrogen-type zeolite of the present application is lower, and the catalytic activity of the Cu-based zeolite is higher; the composite zeolite SCR catalyst comprises the Cu-based zeolite and the first hydrogen-type zeolite, and the composite zeolite SCR catalyst has a similar catalytic performance as the same mass of Cu-based zeolite; meanwhile, the composite zeolite SCR catalyst has a superior hydrothermal stability than the same mass of Cu-based zeolite.

In summary, the composite zeolite SCR catalyst provided by the present application has a similar catalytic performance as the same mass of Cu-based zeolite; meanwhile, the composite zeolite SCR catalyst has a superior hydrothermal stability than the same mass of Cu-based zeolite; the composite zeolite SCR catalyst provided by the present application has a NOₓ removal efficiency of more than or equal to 80% at more than or equal to 300° C.; after the hydrothermal treatment at 750-950° C. for 10-16 h, the hydrothermally treated composite zeolite SCR catalyst has a NOₓ removal efficiency of more than or equal to 60% at more than or equal to 300° C.; the composite zeolite SCR catalyst of the present application is used in the technology of selective catalytic reduction on nitrogen oxides with ammonia, and the composite zeolite SCR catalyst has simple composition, low preparation cost, great catalytic performance and good hydrothermal stability.

Although the embodiments of the present application are described above, the protection scope of the present application is not limited thereto. It should be apparent to those skilled in the art that any changes or substitutions, which are obvious under the technical teaching disclosed by the present application, shall all fall within the protection scope and disclosure scope of the present application.

1. A composite zeolite SCR catalyst, comprising:
a Cu-based zeolite; and
a first hydrogen-type zeolite;
wherein the composite zeolite SCR catalyst has a NOₓ removal efficiency of more than or equal to 80% at more than or equal to 300° C.;
wherein the composite zeolite SCR catalyst is subjected to hydrothermal treatment at 750-950° C. for 10-16 h, and the hydrothermally treated composite zeolite SCR catalyst has a NOₓ removal efficiency of more than or equal to 60% at more than or equal to 300° C.

2. The composite zeolite SCR catalyst according to claim 1,
wherein the Cu-based zeolite and the first hydrogen-type zeolite have a mass ratio of (3-30):3.

3. A preparation method for the composite zeolite SCR catalyst according to claim 1, comprising:
mixing the Cu-based zeolite with the first hydrogen-type zeolite to obtain the composite zeolite SCR catalyst.

4. The preparation method according to claim 3, wherein the Cu-based zeolite has a structural type comprising any one or a combination of at least two of CHA, AEI, KFI, LTA, AFX, ERI, GIS, LEV, RTH, RHO or SFW.

5. The preparation method according to claim 3, wherein the Cu-based zeolite contains Cu in a mass fraction of not less than 2.4 wt % based on a mass of the Cu-based zeolite.

6. The preparation method according to claim 3, wherein silicon dioxide and aluminum oxide in the Cu-based zeolite have a molar ratio of (5-20):1.

7. The preparation method according to claim 3, wherein the first hydrogen-type zeolite has a structural type comprising any one or a combination of at least two of CHA, AEI, KFI, LTA, AFX, ERI, GIS, LEV, RTH, RHO or SFW.

8. The preparation method according to claim 3, wherein a molar ratio of silicon dioxide to aluminum oxide in the first hydrogen-type zeolite is not less than the molar ratio of silicon dioxide to aluminum oxide in the Cu-based zeolite.

9. The preparation method according to claim 3, wherein the mixing comprises any one or a combination of at least two of liquid-liquid mixing, solid-liquid mixing, or solid-solid mixing.

10. The preparation method according to claim 9, wherein the solid-solid mixing comprises grinding.

11. The preparation method according to claim 3, wherein a preparation method for the Cu-based zeolite comprises the following steps:
(1) mixing a second hydrogen-type zeolite with an ammonium chloride solution, and performing filtering and drying to obtain an intermediate; and
(2) mixing the intermediate with a copper salt solution, and performing filtering, drying and then calcining to obtain the Cu-based zeolite.

12. The preparation method according to claim 11, wherein the mixing in step (1) has a temperature of 60-90° C.;
preferably, a method of the mixing in step (1) comprises stirring at a speed of 300-700 rpm;
preferably, the second hydrogen-type zeolite and the ammonium chloride solution in step (1) have a solid-liquid ratio of 1:(80-120), and the solid-liquid ratio has a unit of g/mL;
preferably, the ammonium chloride solution in step (1) has a concentration of 0.1-0.2 mol/L;
preferably, the drying in step (1) has a temperature of 80-120° C.;
preferably, the mixing in step (2) has a temperature of 40-60° C.;
preferably, a method of the mixing in step (2) comprises stirring at a speed of 300-700 rpm;
preferably, the intermediate and the copper salt solution in step (2) have a solid-liquid ratio of 1:(80-120), and the solid-liquid ratio has a unit of g/mL;
preferably, a copper salt in the copper salt solution in step (2) comprises any one or a combination of at least two of copper acetate, copper nitrate or copper sulfate;
preferably, the copper salt solution in step (2) has a concentration of 0.1-0.5 mol/L;
preferably, the drying in step (2) has a temperature of 80-120° C.;
preferably, the calcining in step (2) has a temperature of 400-600° C. and a time of 5-8 h.

13. (canceled)

14. (canceled)

15. The composite zeolite SCR catalyst according to claim 2, wherein the Cu-based zeolite and the first hydrogen-type zeolite have a mass ratio of (6-15):3.

16. A method for selective catalytic reduction on nitrogen oxides from diesel vehicle exhaust with the composite zeolite SCR catalyst according to claim 1.

17. The method according to claim 15, wherein the composite zeolite SCR catalyst is mixed with an additive to obtain a slurry, and the slurry is coated on a honeycomb ceramic, and dried and roasted in sequence to be used for selective catalytic reduction on nitrogen oxides from diesel vehicle exhaust.
